(19) United States
(12) Patent Application Publication
(10) Pub. No.: US 2012/0262636 A1
(43) Pub. Date: Oct. 18, 2012

(54) THREE-DIMENSIONAL GLASSES AND POWER SUPPLYING METHOD THEREOF

(75) Inventors: MING-CHENG LIN, Hsin-Chu (TW); YU-HSIANG HUANG, Hsin-Chu (TW)

(73) Assignee: CORETRONIC CORPORATION, Hsin-Chu (TW)

(21) Appl. No.: 13/304,388

(22) Filed: Nov. 24, 2011

(30) Foreign Application Priority Data
Apr. 15, 2011 (CN) 201110097071.4

(51) Int. Cl. G02F 1/1333; G02B 27/22

(52) U.S. Cl. 349/13; 359/464

(57) ABSTRACT

A three-dimensional glasses including a glasses main body, a touch control circuit, a first and a second touch sensing interfaces, a glasses circuit system and a power supplying module is provided. The glasses main body has a first and a second sensing portions. The touch control circuit and the glasses circuit system are disposed in the glasses main body. The first and the second touch sensing interfaces are disposed at the first and the second sensing portions, electrically connected to the touch control circuit, and respectively transmit a first and a second input signals to the touch control circuit. After the touch control circuit receives the first and the second input signals, the touch control circuit transmits a power supplying signal to the power supplying module to drive the power supplying module to supply power to the glasses circuit system. Besides, a power supplying method is also provided.

### CROSS-REFERENCE TO RELATED APPLICATION

This application claims the priority benefit of China application serial no. 201110097071.4, filed on Apr. 15, 2011. The entirety of the above-mentioned patent application is hereby incorporated by reference herein and made a part of this specification.

### BACKGROUND OF THE INVENTION

1. Field of the Invention

The invention relates to an optical device and a power supplying method of the optical device. Particularly, the invention relates to a three-dimensional glasses and a power supplying method of the three-dimensional glasses.

2. Description of Related Art

Along with development of display technology, three-dimensional displays are gradually popularised, and an operation principle thereof is to ensure a left eye and a right eye of a user to respectively view different images, so as to synthesize a three-dimensional image in the brain. In order to achieve such effect, in some three-dimensional display mechanisms, the user is required to wear a pair of three-dimensional glasses, and the three-dimensional glasses are grouped into active three-dimensional glasses and passive three-dimensional glasses.

Taking the active three-dimensional glasses as an example, it may receive a sync signal from the three-dimensional display. When the three-dimensional display shows a left-eye image, the three-dimensional glasses shields a right-eye lens, so that only the left eye of the user can view a display content of the three-dimensional display. Similarly, when the three-dimensional display shows a right-eye image, the three-dimensional glasses shields a left-eye lens, so that only the right eye of the user can view a display content of the three-dimensional display. In this way, the user may feel a three-dimensional image.

Generally, a switch is set on the three-dimensional glasses to facilitate the user turning on the three-dimensional glasses to execute the above functions of receiving the synch signal and shielding the left-eye lens or the right-eye lens. However, after the use of the three-dimensional glasses, the user may forget to turn off the switch of the three-dimensional glasses, and the three-dimensional glasses continually consumes power to waste energy. Moreover, if the switch is a mechanical switch, it can be damaged due to excessive pressing force, or a keystroke operation thereof is not smooth due to assembling or manufacturing tolerances. Moreover, external moisture may enter the internal of the three-dimensional glasses through fissures around the mechanical button, so that the three-dimensional glasses has a poor water proof effect.

Taiwan Patent No. TW200819817 discloses a pair of liquid crystal glasses having a touch switch, and the touch switch can be set on a glasses leg or other suitable positions.

### SUMMARY OF THE INVENTION

The invention is directed to a three-dimensional glasses and a power supplying method thereof, and when a user wears the three-dimensional glasses, a power supplying module is turned on according to sensing results of touch sensing interfaces.

Additional aspects and advantages of the invention will be set forth in the description of the techniques disclosed in the invention.

To achieve one of or all aforementioned and other advantages, an embodiment of the invention provides a three-dimensional glasses including a glasses main body, a touch control circuit, a first touch sensing interface, a second touch sensing interface, a glasses circuit system and a power supplying module. The glasses main body has a first sensing portion and a second sensing portion. The touch control circuit is disposed in the glasses main body. The first touch sensing interface is disposed at the first sensing portion and the first touch sensing interface is electrically connected to the touch control circuit. The first touch sensing interface is adapted to transmit a first input signal to the touch control circuit. The second touch sensing interface is disposed at the second sensing portion and the second touch sensing interface is electrically connected to the touch control circuit. The second touch sensing interface is adapted to transmit a second input signal to the touch control circuit. The glasses circuit system is disposed in the glasses main body and has two liquid crystal lenses, a liquid crystal driving circuit and a three-dimensional synchronization circuit. The power supplying module is disposed in the glasses main body and is electrically connected to the touch control circuit and the glasses circuit system. After the touch control circuit receives the first input signal and the second input signal, the touch control circuit transmits a power supplying signal to the power supplying module to drive the power supplying module to supply power to the glasses circuit system.

In an embodiment of the invention, the glasses main body includes two nose pads, and the first sensing portion and the second sensing portion are respectively located at the two nose pads.

In an embodiment of the invention, the glasses main body includes two glasses legs, and the first sensing portion and the second sensing portion are respectively located at the two glasses legs.

In an embodiment of the invention, the power supplying module includes a battery and a switch device, the switch device is electrically connected to the battery and the glasses circuit system, and the switch device is electrically connected to the touch control circuit, wherein the touch control circuit is adapted to transmit the power supplying signal to the switch device to turn on the switch device such that the battery is adapted to supply power to the glasses circuit system.

In an embodiment of the invention, the battery is electrically connected to the first touch sensing interface and the second touch sensing interface for supplying power to the first touch sensing interface and the second touch sensing interface.

In an embodiment of the invention, the first touch sensing interface and the second touch sensing interface are capacitive touch devices.

In an embodiment of the invention, when the touch control circuit continually receives the first input signal during a time section, and continually receives the second input signal during the same time section, the touch control circuit is adapted to generate the power supplying signal.

In an embodiment of the invention, the glasses main body includes two nose pads and two glasses legs, the first sensing portion is located at one of the two nose pads, and the second sensing portion is located at one of the two glasses legs.

In an embodiment of the invention, at least one of the first sensing portion and the second sensing portion is located at an inner side of the glasses main body.

To achieve one of or all aforementioned and other advantages, an embodiment of the invention provides a power supplying method of a three-dimensional glasses. The three-dimensional glasses includes a touch control circuit, a first touch sensing interface, a second touch sensing interface, a glasses circuit system and a power supplying module. First, it is determined whether the touch control circuit receives a first input signal from the first touch sensing interface and a second input signal from the second touch sensing interface. Then, after the touch control circuit receives the first input signal and the second input signal, the touch control circuit transmits the power supplying signal to the power supplying module to drive the power supplying module to supply power to the glasses circuit system.

In an embodiment of the invention, the power supplying method of the three-dimensional glasses further includes that the touch control circuit stops transmitting the power supplying signal to the power supplying module such that the power supplying module stops supplying power to the glasses circuit system when the touch control circuit does not receive the first input signal and the second input signal.

In an embodiment of the invention the power supplying method of the three-dimensional glasses further includes following steps. After the touch control circuit receives the first input signal and the second input signal, it is determined whether the touch control circuit continually receives the first input signal during a time section, and continually receives the second input signal during the same time section, and when the touch control circuit continually receives the first input signal during the time section and continually receives the second input signal during the same time section, the touch control circuit generates the power supplying signal.

In an embodiment of the invention, the power supplying method of the three-dimensional glasses further includes that the touch control circuit stops transmitting the power supplying signal to the power supplying module such that the power supplying module stops supplying power to the glasses circuit system when the touch control circuit does not continually receive the first input signal during the time section or does not continually receive the second input signal during the same time section.

According to the above descriptions, in the embodiments of the invention, the three-dimensional glasses has the first touch sensing interface and the second touch sensing interface respectively located at different locations, and the first touch sensing interface and the second touch sensing interface drive the power supplying module to supply power after sensing touch inputs. When the user wears the three-dimensional glasses, the power supplying module can be turned on based on contact or approach between the nose, the ear, the face or other body parts of the user and the first touch sensing interface and the second touch sensing interface, and when the three-dimensional glasses is no longer worn by the user, since none contact or approach is sensed by the first touch sensing interface and the second touch sensing interface, the power supplying module is automatically turned off. In this way, waste of energy due to that the three-dimensional glasses is maintained in a turned-on state when it is not used can be avoided. By using at least two touch sensing interfaces to operate the power supplying module, turning on/off of the function of the three-dimensional glasses due to miss touch or miss operation of the user can be avoided. Moreover, since the touch sensing interfaces are used to switch the three-dimensional glasses other than using a mechanical switch, damage of the device due to excessive pressing force can be avoided, and un-smoothness of a keystroke operation caused by assembling or manufacturing tolerances can be avoided. Moreover, the touch sensing interface may sense contact or approach of human body, so that the first touch sensing interface and the second touch sending interface can be totally embedded inside a casing surface of the glasses main body, and it is unnecessary to bore the casing of the glasses main body, which avails improving the water-proof capability of the three-dimensional glasses.

Other objectives, features and advantages of the invention will be further understood from the further technological features disclosed by the embodiments of the invention wherein there are shown and described preferred embodiments of the invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a three-dimensional glasses according to an embodiment of the invention.

FIG. 2 is a block diagram of a part of components of the three-dimensional glasses of FIG. 1.

FIG. 3 is a three-dimensional view of a three-dimensional glasses according to another embodiment of the invention.

FIG. 4 is a flowchart illustrating a power supplying method of a three-dimensional glasses.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

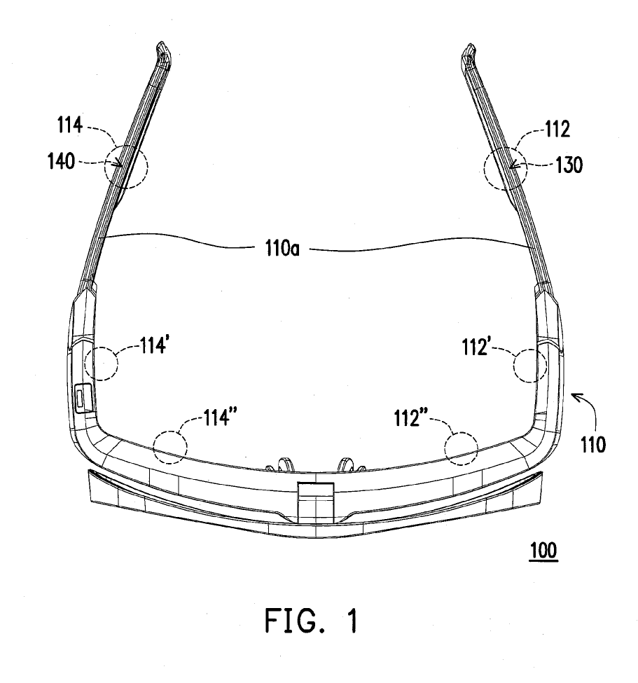

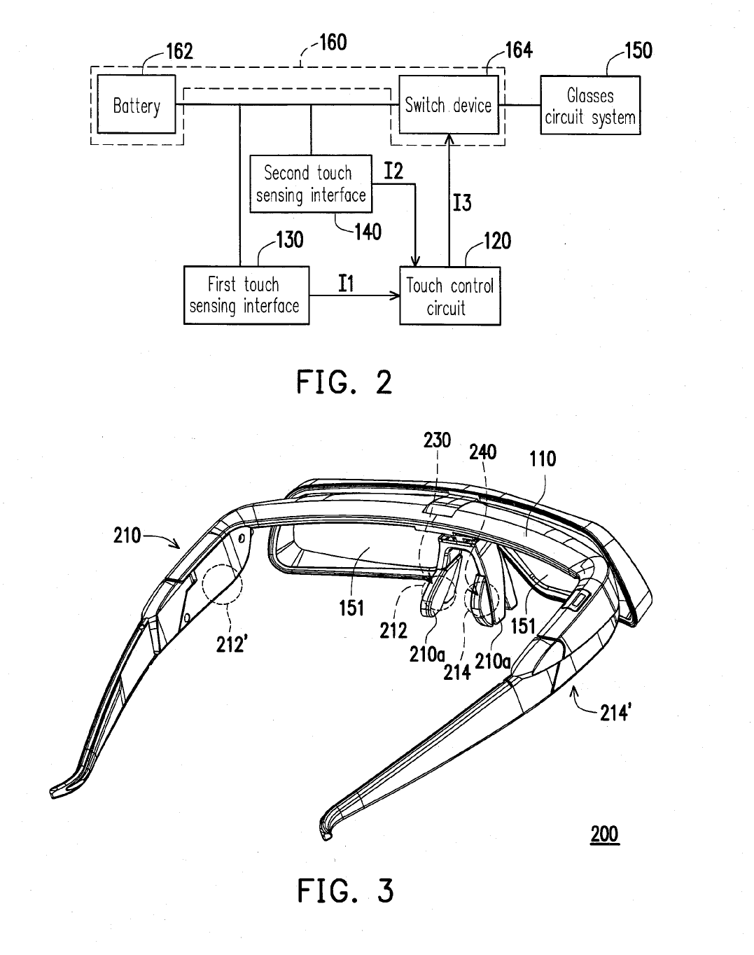

FIG. 1 is a top view of a three-dimensional glasses according to an embodiment of the invention. FIG. 2 is a block diagram of a part of components of the three-dimensional glasses of FIG. 1. Referring to FIG. 1 and FIG. 2, the three-dimensional glasses 100 of the embodiment includes a glasses main body 110, a touch control circuit 120, a first touch sensing interface 130, a second touch sensing interface 140, a glasses circuit system 150 and a power supplying module 160. The touch control circuit 120, the glasses circuit system 150 and the power supplying module 160 are disposed in the glasses main body 110. The touch control circuit 120 is electrically connected to the power supplying module 160, and the power supplying module 160 is electrically connected to the glasses circuit system 150. The glasses circuit system 150 includes two liquid crystal lenses 151, a liquid crystal driving circuit and a three-dimensional synchronization circuit (not shown), etc.

The glasses main body 110 has a first sensing portion 112 and a second sensing portion 114. The first touch sensing interface 130 is disposed at the first sensing portion 112 and is electrically connected to the touch control circuit 120. The second touch sensing interface 140 is disposed at the second sensing portion 114 and is electrically connected to the touch control circuit 120. The first touch sensing interface 130 is adapted to sense contact or approach of human body and transmit a first input signal I1 to the touch control circuit 120. The second touch sensing interface 140 is adapted to sense contact or approach of human body and transmit a second input signal I2 to the touch control circuit 120. After the touch control circuit 120 receives the first input signal I1 and the second input signal I2, the touch control circuit 120 transmits a power supplying signal I3 to the power supplying module 160 to drive the power supplying module 160 to supply power to the glasses circuit system 150, so that the function of the three-dimensional glasses 100 is turned on.

The first sensing portion 112 and the second sensing portion 114 of the present embodiment are, for example, respectively located at two glasses legs 110a of the glasses main body 110. When the user wears the three-dimensional glasses 100, the first sensing portion 112 and the second sensing portion 114 respectively contact or approach two ears or the face of the user, and the power supplying module 160 is turned on according to the contact or approach of the two ears or the face and the first touch sensing interface 130 and the second touch sensing interface 140. When the three-dimensional glasses 100 is not worn, since none contact or approach of the ears or the face of the user is sensed by the first touch sensing interface 130 and the second touch sensing interface 140, the power supplying module 160 is automatically turned off. In this way, waste of energy due to that the three-dimensional glasses is maintained in a turned-on state when it is not used can be avoided. By using at least two touch sensing interfaces to operate the power supplying module 160, turning on/off of the function of the three-dimensional glasses 100 due to miss touch or miss operation of the user can be avoided. Moreover, since the first touch sensing interface 130 and the second touch sensing interface 140 are used as the switches of the three-dimensional glasses other than using a mechanical switch, damage of the device due to excessive pressing force can be avoided, and un-smoothness of a keystroke operation caused by assembling or manufacturing tolerances can be avoided. Moreover, the touch sensing interface may sense contact or approach of human body, so that the first touch sensing interface 130 and the second touch sending interface 140 can be totally embedded inside a casing surface of the glasses main body 110, and it is unnecessary to bore the casing of the glasses main body 110, which avails improving the water-proof capability of the three-dimensional glasses 100.

In the embodiment, the first touch sensing interface 130 and the second touch sensing interface 140 are, for example, capacitive touch devices embedded inside the casing surface of the glasses main body, which are adapted to sense contact or approach of human body to generate the aforementioned first input signal I1 and the second input signal I2.

In another embodiment, a first sensing portion 112′ and a second sensing portion 114′ are, for example, located at an inner side of the glasses main body 110, or a first sensing portion 112″ and a second sensing portion 114″ are located at an inner side of a glasses frame, and the first touch sensing interface 130 and the second touch sensing interface 140 may sense contact and approach of the human face. In other embodiments, one of the first sensing portion and the second sensing portion is located at the glasses leg, and another one is located at the inner side of the glasses main body or the inner side of the glasses frame.

Referring to FIG. 2, in detail, the power supplying module 160 includes a battery 162 and a switch device 164. The switch device 164 is electrically connected to the battery 162 and the glasses circuit system 150, and the switch device 164 is electrically connected to the touch control circuit 120. After the touch control circuit 120 receives the first input signal I1 from the first touch sensing interface 130 and the second input signal I2 from the second touch sensing interface 140, the touch control circuit 120 transmits the power supplying signal I3 to the switch device 164 to turn on the switch device 164 such that the battery 162 supplies power to the glasses circuit system 150. Moreover, the battery 162 is electrically connected to the first touch sensing interface 130 and the second touch sensing interface 140 to supply power to the first touch sensing interface 130 and the second touch sensing interface 140.

Further, the touch control circuit 120 of the present embodiment can be designed as follows. When the touch control circuit 120 continually receives the first input signal I1 during a time section, and continually receives the second input signal I2 during the same time section, the touch control circuit 120 generates the power supplying signal I3, and transmits the power supplying signal I3 to the power supplying module 160. In this way, only when the user indeed wears the three-dimensional glasses 100 and the first touch sensing interface 130 and the second touch sensing interface 140 continually sense the contact or approach of the human body for a specific duration, the power supplying module 160 is turned on, so as to avoid a situation that the power supplying module 160 is turned on due to miss contact of the first sensing portion 112 and the second sensing portion 114. The aforementioned duration is, for example, one second, two seconds or other suitable time lengths, which is not limited by the invention.

FIG. 3 is a three-dimensional view of a three-dimensional glasses according to another embodiment of the invention. Referring to FIG. 3, compared to the three-dimensional glasses 100 of FIG. 1 that the first sensing portion 112 and the second sensing portion 114 are respectively disposed at two glasses legs 110a, a first sensing portion 212 and a second sensing portion 214 of the three-dimensional glasses 200 of the embodiment are respectively disposed at two nose pads 210a of a glasses main body 210. When the user wears the three-dimensional glasses 200, the first sensing portion 212 and the second sensing portion 214 may contact the user's nose, and the three-dimensional glasses 200 is turned on according to the contact between the nose and a first touch sensing interface 230 on the first sensing portion 212 and a second touch sensing interface 240 on the second sensing portion 214. When the three-dimensional glasses 200 is not worn, since none touch input from the user's nose is sensed by the first touch sensing interface 230 and the second touch sensing interface 240, the three-dimensional glasses 200 is automatically turned off.

In another embodiment, a first sensing portion 212′ and a second sensing portion 214′ of the three-dimensional glasses 200 are respectively located an inner side the glasses main body 210 to facilitate the touch sensing interfaces sensing the approach of human face. In other embodiments, one of the first sensing portion 212 and the second sensing portion 214 can be located at the glasses leg or the nose pad, and another one is located at the inner side of the glasses main body 210 or the inner side of the glasses frame, which is not limited by the invention.

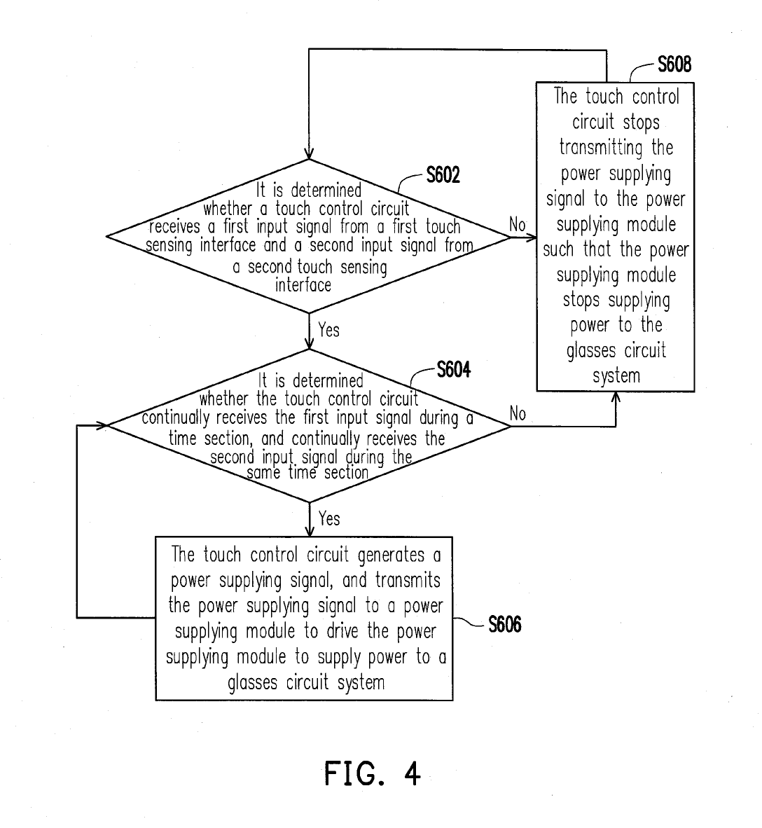

The three-dimensional glasses 100 of FIG. 1 and FIG. 2 is taken as an example to describe a power supplying method of the three-dimensional glasses. FIG. 4 is a flowchart illustrating a power supplying method of a three-dimensional glasses. Referring to FIG. 2 and FIG. 4, first, it is determined whether the touch control circuit 120 receives the first input signal I1 from the first touch sensing interface 130 and the second input signal I2 from the second touch sensing interface 140 (step S602). If the touch control circuit 120 receives the first input signal I1 and the second input signal I2, it is determined whether the touch control circuit 120 continually receives the first input signal I1 during a time section, and continually receives the second input signal I2 during the same time section (step S604). When the touch control circuit 120 continually receives the first input signal I1 during the time section and continually receives the second input signal I2 during the same time section, the touch control circuit 120 generates the power supplying signal I3, and transmits the power supplying signal I3 to the power supplying module 160 to drive the power supplying module 160 to supply power to the glasses circuit system 150 (step S606).

In detail, in the step S606, the power supplying signal I3 generated by the touch control circuit 120 is transmitted to the switch device 164 of the power supplying module 160 to turn on the switch device 164, so that the battery 162 of the power supplying module 160 supplies power to the glasses circuit system 150.

After the step S602, if the touch control circuit 120 does not receive the first input signal I1 and the second input signal I2, touch control circuit 120 stops transmitting the power supplying signal I3 to the power supplying module 160 such that the power supplying module 160 stops supplying power to the glasses circuit system 150 (step S608). Moreover, after the step S604, if the touch control circuit 120 does not continually receive the first input signal I1 during the time section or does not continually receive the second input signal I2 during the same time section, the touch control circuit 120 stops transmitting the power supplying signal I3 to the power supplying module 160 such that the power supplying module 160 stops supplying power to the glasses circuit system 150 (step S608).

In summary, in the embodiments of the invention, the three-dimensional glasses has the first touch sensing interface and the second touch sensing interface respectively located at different location, and the first touch sensing interface and the second touch sensing interface drive the power supplying module to supply power after sensing touch inputs. When the user wears the three-dimensional glasses, the power supplying module can be turned on based on contact or approach between the nose, the ear, the face or other body parts of the user and the first touch sensing interface and the second touch sensing interface, and when the three-dimensional glasses is no longer worn by the user, since none contact or approach is sensed by the first touch sensing interface and the second touch sensing interface, the power supplying module is automatically turned off. In this way, waste of energy due to that the three-dimensional glasses is maintained in a turned-on state when it is not used can be avoided. By using at least two touch sensing interfaces to operate the power supplying module, turning on/off of the function of the three-dimensional glasses due to miss touch or miss operation of the user can be avoided. Moreover, since the touch sensing interfaces are used to switch the three-dimensional glasses other than using a mechanical switch, damage of the device due to excessive pressing force can be avoided, and un-smoothness of a keystroke operation caused by assembling or manufacturing tolerances can be avoided. Moreover, the touch sensing interface may sense contact or approach of human body, so that the first touch sensing interface and the second touch sending interface can be totally embedded inside a casing surface of the glasses main body, and it is unnecessary to bore the casing of the glasses main body, which avails improving the water-proof capability of the three-dimensional glasses.

The first touch sensing interface, the second touch sensing interface, the first sensing portion, the second sensing portion, and others mentioned in the description of the invention are all used to represent names of the devices, which are not used as an upper limit or a lower limit of the device number.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A three-dimensional glasses, comprising:
a glasses main body, comprising a first sensing portion and a second sensing portion;
a touch control circuit, disposed in the glasses main body;
a first touch sensing interface, disposed at the first sensing portion, and electrically connected to the touch control circuit, wherein the first touch sensing interface is adapted to transmit a first input signal to the touch control circuit;
a second touch sensing interface, disposed at the second sensing portion and electrically connected to the touch control circuit, wherein the second touch sensing interface is adapted to transmit a second input signal to the touch control circuit;
a glasses circuit system, disposed in the glasses main body, and having two liquid crystal lenses, a liquid crystal driving circuit and a three-dimensional synchronization circuit; and
a power supplying module, disposed in the glasses main body and electrically connected to the touch control circuit and the glasses circuit system, wherein after the touch control circuit receives the first input signal and the second input signal, the touch control circuit is adapted to transmit a power supplying signal to the power supplying module to drive the power supplying module to supply power to the glasses circuit system.

2. The three-dimensional glasses as claimed in claim 1, wherein the glasses main body comprises two nose pads, and the first sensing portion and the second sensing portion are respectively located at the two nose pads.

3. The three-dimensional glasses as claimed in claim 1, wherein the glasses main body comprises two glasses legs, and the first sensing portion and the second sensing portion are respectively located at the two glasses legs.

4. The three-dimensional glasses as claimed in claim 1, wherein the power supplying module comprises:
a battery; and
a switch device electrically connected to the battery, the glasses circuit system, and the touch control circuit, wherein the touch control circuit is adapted to transmit the power supplying signal to the switch device to turn on the switch device such that the battery supplies power to the glasses circuit system.

5. The three-dimensional glasses as claimed in claim 1, wherein the battery is electrically connected to the first touch sensing interface and the second touch sensing interface for supplying power to the first touch sensing interface and the second touch sensing interface.

6. The three-dimensional glasses as claimed in claim 1, wherein the first touch sensing interface and the second touch sensing interface are capacitive touch devices.

7. The three-dimensional glasses as claimed in claim 1, wherein when the touch control circuit continually receives the first input signal during a time section, and continually receives the second input signal during the same time section, the touch control circuit is adapted to generate the power supplying signal.

8. The three-dimensional glasses as claimed in claim 1, wherein the glasses main body comprises two nose pads and two glasses legs, the first sensing portion is located at one of the two nose pads, and the second sensing portion is located at one of the two glasses legs.

9. The three-dimensional glasses as claimed in claim 1, wherein at least one of the first sensing portion and the second sensing portion is located at an inner side of the glasses main body.

10. A power supplying method of a three-dimensional glasses, the three-dimensional glasses comprising a touch control circuit, a first touch sensing interface, a second touch sensing interface, a glasses circuit system and a power supplying module, and the power supplying method of the three-dimensional glasses comprising:
determining whether the touch control circuit receives a first input signal from the first touch sensing interface and a second input signal from the second touch sensing interface; and
transmitting a power supplying signal from the touch control circuit to the power supplying module so as to drive the power supplying module to supply power to the glasses circuit system after the touch control circuit receives the first input signal and the second input signal.

11. The power supplying method of the three-dimensional glasses as claimed in claim 10, wherein the power supplying module comprises a battery and a switch device, the switch device is electrically connected to the battery and the glasses circuit system, and the switch device is electrically connected to the touch control circuit, and the step of driving the power supplying module to supply power comprises:
the touch control circuit transmitting the power supplying signal to the switch device to turn on the switch device such that the battery supplies power to the glasses circuit system.

12. The power supplying method of the three-dimensional glasses as claimed in claim 10, further comprising:
the touch control circuit stopping transmitting the power supplying signal to the power supplying module such that the power supplying module stops supplying power to the glasses circuit system when the touch control circuit does not receive the first input signal and the second input signal.

13. The power supplying method of the three-dimensional glasses as claimed in claim 10, further comprising:
determining whether the touch control circuit continually receives the first input signal during a time section, and continually receives the second input signal during the same time section after the touch control circuit receives the first input signal and the second input signal; and
the touch control circuit generating the power supplying signal when the touch control circuit continually receives the first input signal during the time section and continually receives the second input signal during the same time section.

14. The power supplying method of the three-dimensional glasses as claimed in claim 13, further comprising:
the touch control circuit stopping transmitting the power supplying signal to the power supplying module such that the power supplying module stops supplying power to the glasses circuit system when the touch control circuit does not continually receive the first input signal during the time section or does not continually receive the second input signal during the same time section.
